(19) United States
(12) Patent Application Publication
(10) Pub. No.: US 2015/0360588 A1
(43) Pub. Date: Dec. 17, 2015

(54) LOCKING DEVICE

(71) Applicant: JOHNSON CONTROLS GMBH, Burscheid (DE)

(72) Inventors: Joachim FLICK, Hückeswagen (DE); Falko JÄHNER, Kaiserslautern (DE)

(73) Assignee: Johnson Controls GmbH, Burscheid (DE)

(21) Appl. No.: 14/761,124

(22) PCT Filed: Feb. 6, 2014
(86) PCT No.: PCT/EP2014/052278

§ 371 Date: Jul. 15, 2015

(30) Foreign Application Priority Data
Feb. 7, 2013 (DE) 10 2013 002 066.2
May 27, 2013 (DE) 10 2013 008 871.2

(51) Int. Cl. B60N 2/08; B60N 2/07

(52) U.S. Cl. CPC B60N 2/0862; B60N 2/0727

(57) ABSTRACT

A locking mechanism (7) is provided for the longitudinal adjustment of a vehicle seat, by which a first rail (3) can be fixed relative to a second rail (4). A fixing device (5) is connected to one of the rails and fixes the rail by reversibly engaging a recess (6) in the other rail. A vehicle seat is also provided having the locking mechanism. A process is provided for producing the locking mechanism.

### CROSS REFERENCE TO RELATED APPLICATIONS

This application is a United States National Phase Application of International Application PCT/EP2014/052278 filed Feb. 6, 2014 and claims the benefit of priority under 35 U.S.C. §119 of German Patent Applications 10 2013 002 066.2 filed Feb. 7, 2013 and 10 2013 008 871.2 filed May 27, 2013, the entire contents of which are incorporated herein by reference.

### FIELD OF THE INVENTION

The present invention relates to a locking device which is for the longitudinal adjustment of a vehicle seat and by means of which a first rail can be secured relative to a second rail and which has a securing means which is connected to one rail and which for securing engages in a reversible manner in a recess in the other rail. Furthermore, the present invention relates to a vehicle seat having the locking device according to the invention and a method for producing the locking device.

### BACKGROUND OF THE INVENTION

Nowadays, vehicle seats generally have a longitudinal adjustment by means of which the position of the vehicle seat can be adapted in and counter to the travel direction in order to adapt the vehicle seat to the size of the respective seat occupant. To this end, the vehicle seats have a first rail, the upper rail, which is preferably connected to the seat member of the vehicle seat and a second lower rail which is preferably connected to the vehicle bodywork. For longitudinal adjustment of the vehicle seat, the upper rail is moved relative to the lower rail and, as soon as the desired position has been found, the upper rail is secured with a locking device. This locking device has at least one, preferably a plurality of, securing means, for example, a bolt which is directly or indirectly connected to one of the rails and which for securing engages in a recess in the other rail. This locking means has to absorb all the forces, in particular also the forces which occur in the event of an accident, in order to prevent the vehicle seat from moving unintentionally relative to the vehicle bodywork. In the event of highly dynamic occurrences of loading, as occur in particular in accident situations, in the event of an unfavorable contact between the surface of the securing means and the surface of the recess or in the event of unfavorable friction conditions, in particular in connection with oscillations, in particular high-frequency oscillation portions, the respective securing means may become released from the securing position thereof in an undesirable manner, which can lead to a longitudinal adjustment of the vehicle seat.

### SUMMARY OF THE INVENTION

An object of the present invention is therefore to provide a locking device which does not have the disadvantages of the prior art.

The object is achieved with a locking device which is for the longitudinal adjustment of a vehicle seat and by means of which a first rail can be secured relative to a second rail and which has a securing means which is directly or indirectly connected to one rail and which for securing engages in a reversible manner in a recess in the other rail, wherein the surface of the securing means and/or the recess is processed, in particular mechanically, and coated with a coating which increases the friction coefficient.

The disclosure which has been made the subject-matter of the present invention applies equally to the vehicle seat according to the invention and the method according to the invention and vice versa.

The present invention relates to the locking device for the longitudinal adjustment of a vehicle seat. With the longitudinal adjustment, the vehicle seat may, for example, be displaced in and counter to the travel direction of the vehicle in order to adapt the position of the vehicle seat to the respective size of the vehicle seat occupant. The longitudinal adjustment has a first and a second rail, the first rail generally being securely connected to the vehicle seat and the second rail being securely connected to the bodywork. The rails are preferably produced from bent or extruded material. The metal may be at least locally hardened. Between the two rails, rolling members are preferably provided in order to facilitate the movement of the first rail relative to the second rail. According to the invention, the locking device has a securing means (comprising a securing element) by means of which the position of the second rail can be fixed relative to the first rail. This securing means is securely connected to one of the two rails directly or indirectly and according to the invention engages for securing in a reversible manner in a recess which is provided in the other rail. The securing means may, for example, be a bolt which engages for securing of the two rails relative to each other in a reversible manner in a recess in the other rail. Preferably, the locking device has a plurality of securing means, for example, a plurality of bolts, which each engage in a reversible manner with an in particular separate recess in the other rail. Preferably, in particular in the region which cooperates with the recess, the bolts are at least partially provided in a conical manner. Each bolt is preferably produced from metal, in particular from steel. In a particularly preferred manner, the metal is at least partially hardened. In a particularly preferred manner, each recess is also constructed in a conical manner, wherein the angle of the cone of the recess preferably corresponds to the angle of the conical portion of the bolt.

According to the invention, the surface of the securing means and/or the surface of the recess is processed, in particular mechanically. During this processing operation, in particular a surface layer, for example, a corrosion or scale layer, which is formed, for example, when the securing means is hardened, is at least partially removed. Examples of mechanical processing of the surface are shot-peening or sand-blasting.

Alternatively, however, the layer may also be removed by removing chips or brushed away. In another alternative manner, the layer can be removed by means of sound waves, in particular ultrasound waves, in a chemical or electrochemical manner. However, every other method which is commonplace to the person skilled in the art and by means of which a surface layer on the securing means and/or on the recess can be at least partially removed can also be considered.

Subsequently, the processed surface of the securing means and/or the recess is provided with a coating which increases the friction coefficient. The coating may, for example, be the product DeltaSeal RZ.

The combination of the mechanical processing with a subsequent coating which increases the friction coefficient has the advantage that the securing means, even in the event of a highly dynamic loading during an accident, does not become unintentionally released from the recess.

A coating which increases the friction coefficient in the context of the invention is any coating in which the friction coefficient of the pair: surface of the recess/surface of the securing means is greater than the friction coefficient of the pair: metal surface of the recess/metal surface of the securing means, at least one of the last surfaces mentioned being able to be provided with a corrosion and/or scale layer.

Another aspect of subject-matter of the present invention is a vehicle seat, having the locking device according to the invention for the longitudinal adjustment of the vehicle seat.

The disclosure which has been made the subject-matter of the present invention applies equally to the locking device according to the invention and the method according to the invention and vice versa.

Yet another aspect of subject-matter of the present invention is a method for producing the locking device, wherein the securing means and/or the recess, preferably after the hardening thereof, is/are processed, in particular mechanically, in particular in order to at least partially remove any scale and/or corrosion layer which is present and wherein the surface which has been processed in this manner is subsequently at least partially provided with a coating which increases the friction coefficient.

The disclosure which has been made the subject-matter of the present invention applies equally to the locking device according to the invention and the vehicle seat according to the invention and vice versa.

The invention is explained below with reference to FIGS. 1 and 2. These explanations are merely by way of example and do not limit the general notion of the invention. The explanations apply equally to all the aspects of subject-matter of the present invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view showing an embodiment of the locking device according to the invention;

FIG. 2 is a top partially cutaway view showing an embodiment of a rail.

### DESCRIPTION OF THE PREFERRED EMBODIMENTS

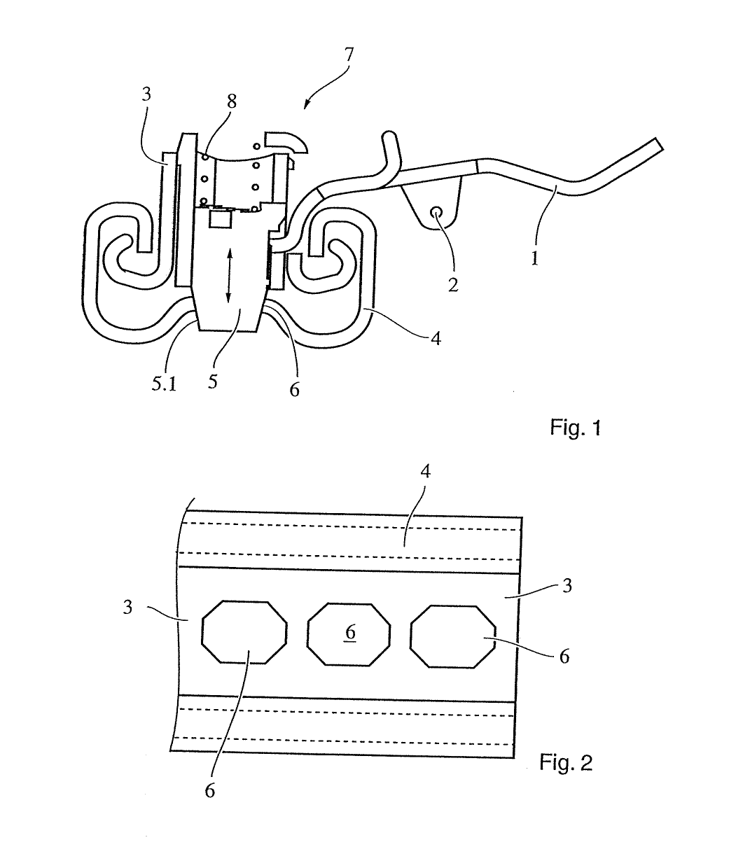

FIG. 1 is a side view of the locking device 7 according to the invention. This locking device is a portion of a longitudinal adjustment unit of a vehicle seat, by means of which unit the vehicle seat can be moved, for example, in or counter to the travel direction of the vehicle, in order to adjust this vehicle seat to the length of the respective seat occupant. The longitudinal adjustment has a first rail 3, in this instance the upper rail, and a second rail 4, in this instance the lower rail. The upper rail 3, which is, for example, securely connected directly or indirectly to the seat member of the vehicle seat, is displaced for longitudinal adjustment relative to the second lower rail 4, which is preferably securely connected to the bodywork of the vehicle. Rolling members (not illustrated) are generally provided between the rails 3 4, in order to reduce the force which is required for longitudinal adjustment of the vehicle seat. As soon as the desired longitudinal position of the vehicle seat has been found, the upper rail 3 is locked relative to the lower rail in order to prevent an independent adjustment of the vehicle seat. To this end, there is provided a locking device 7 which has a securing means 5, in this instance a bolt, which cooperates in a locking manner in the securing position thereof illustrated in this instance with a recess 6 which is provided in the rail 4 so that the rail 3 cannot move independently relative to the rail 4. The bolt 5 may be moved in two opposing directions, as illustrated by the double-headed arrow, by means of the handle 1 which in the present case is provided so as to be able to be rotated about a bearing 2. In the present case, an upward movement brings about the unlocking of the rail 3 from the rail 4 and a downward movement brings about a corresponding locking of the rail 3 relative to the rail 4. The bolt 5 in the present instance according to a preferred embodiment is pretensioned into the locking position thereof by the resilient means 8. Preferably, the locking device has a plurality of securing means, in this instance bolts 5. In a further preferred manner, the securing means, in this instance the bolt 5, is provided at least partially in a conical manner 5.1. Accordingly, the recess which cooperates with the conical portion 5.1 of the securing means is also provided with a corresponding conical chamfer. The bolt 5 is preferably produced from metal, in particular from steel, preferably from hardened steel. In particular after hardening, the bolt may have a scale and/or corrosion layer. The rails 3, 4 are preferably also produced from metal, which may be locally hardened. Preferably, the rail 3, 4 is produced from sheet metal, for example, sheet steel or sheet aluminum.

As can be seen in particular in FIG. 2, the cross-section of the securing means 5 is provided in the present instance as a polygon, in this instance so as to be octagonal. Accordingly, the cross-section of the recesses 6, which is provided in this instance in the lower rail, is also constructed as a polygon, in this instance in an octagonal manner. However, the person skilled in the art understands that the securing means may also have any other cross-section, for example, round, parallelepipedal or square or elliptical. However, polygons or ellipses have the advantage that they can transmit not only shearing forces but also torques. As can further be seen in FIG. 2, the lower rail has a large number of recesses 6 which are preferably arranged so as to be equidistant from each other and which in a particularly preferred manner extend over the entire length of the lower rail in order to achieve the largest possible adjustment range for the longitudinal adjustment. Each securing means 5 cooperates in the present case in a locking manner with a recess 6.

According to the invention, there is now provision for the surface of the securing means and/or the surface of the recess, in particular after at least one of these surfaces has been hardened, to be processed, preferably in a mechanical manner, for example, by means of shot-peening and/or sand-blasting. As a result of this processing, for example, any corrosion and/or scale layer which may be present is removed. Subsequently, at least one of these pre-treated surfaces is provided with a coating which increases the friction coefficient and which results in the friction coefficient between the securing means and the recess being increased in comparison with a metal/metal pairing, of which at least one surface has a corrosion and/or scale layer where applicable. In the present instance, this coating which increases the friction coefficient is a DeltaSeal RZ coating. The coating material may be applied to the securing means and/or the surface of the recess using any means commonplace to the person skilled in the art. For example, it may be sprayed, applied with a brush or applied by means of immersion.

While specific embodiments of the invention have been shown and described in detail to illustrate the application of the principles of the invention, it will be understood that the invention may be embodied otherwise without departing from such principles.

1. A locking device for a longitudinal adjustment of a vehicle seat with a first rail that can be secured relative to a second rail, the locking device comprising:
a securing means for securing one of the rails relative to the other of the rails, the securing means being directly or indirectly connected to one of the rails and, for securing, engages in a reversible manner in a recess in the other one of the rails, wherein at least one of the surface of the securing means and the recess is processed mechanically and is coated with a coating which increases a friction coefficient of the surface.

2. The locking device as claimed in claim 1, further comprising another securing means for securing one of the rails relative to the other of the rails to provide a plurality of securing means which each cooperate with a separate recess.

3. The locking device as claimed in claim 1, wherein the securing means is a bolt.

4. The locking device as claimed in claim 3, wherein the bolt is at least partially conical.

5. The locking device as claimed in claim 4, wherein the recess is provided in a conical manner, wherein the angle of a cone of the recess corresponds to the angle of the conical portion of the bolt.

6. The locking device as claimed in claim 1, wherein the securing means is provided comprising hardened metal.

7. The locking device as claimed in claim 1, wherein a corrosion or scale layer is formed when the securing means is hardened, and the corrosion or scale layer is at least partially removed.

8. The locking device as claimed in claim 1, wherein a cross-section of the securing means and the recess is a polygon.

9. A vehicle seat comprising:
a first rail;
a second rail movable relative to the first rail; and
a securing element for securing the first rail relative to the second rail, the securing element being directly or indirectly connected to one the first rail and comprising a securing element surface that engages in a reversible manner a recess of the second rail, the recess having a recess surface, wherein at least one of the securing element surface and the recess surface is processed mechanically and is coated with a coating which increases a friction coefficient of the surface.

10. (canceled)

11. The vehicle seat as claimed in claim 9, further comprising another securing element to provide a plurality of securing elements, each of the securing elements cooperates with a separate one of recesses.

12. The vehicle seat as claimed in claim 9, wherein:
the securing element is a bolt with a taper; and
the recess is tapered.

13. The vehicle seat as claimed in claim 9, wherein the securing element comprises hardened metal.

14. The vehicle seat as claimed in claim 9, wherein a corrosion or scale layer is formed when the securing element is hardened, and the corrosion or scale layer is at least partially removed.

15. The vehicle seat as claimed in claim 9, wherein a cross-section of the securing element and the recess is a polygon.

16. A method for producing the locking device, the method comprising the steps of:
hardening at least one of a securing element and a recess;
mechanically processing at least one of a securing element and the recess to at least partially remove any scale and/or corrosion layer which is present; and
coating a surface which has been mechanically processed, the coating increasing a friction coefficient of the surface; and
providing a locking device for a longitudinal adjustment of a vehicle seat, which longitudinal adjuster has a first rail that can be secured relative to a second rail, wherein the locking device comprises a securing element for securing one of the rails relative to the other of the rails, the securing element being directly or indirectly connected to one of the rails and the securing element engaging, in a reversible manner, in a recess in the other one of the rails, wherein at least one of a surface of the securing means and a surfaced of the recess comprises the surface which has been mechanically processed and which has the coating increasing a friction coefficient of the surface.

17. The method as claimed in claim 16, further comprising providing another securing element which has been mechanically processed and which has the coating increasing a friction coefficient of the surface to provide a plurality of securing elements, each of the securing elements cooperating with a separate one of the recesses.

18. The method as claimed in claim 16, wherein:
the securing element is a bolt with a taper; and
the recess is tapered.

19. The method as claimed in claim 16, wherein the securing element comprises hardened metal.

20. The method as claimed in claim 16, wherein a cross-section of the securing element and the recess is a polygon.

21. The method as claimed in claim 16, wherein:
the securing element is formed as a bolt;
the bolt is at least partially conical; and
the recess is provided in a conical manner.
